(19) United States
(12) Patent Application Publication
(10) Pub. No.: US 2026/0303474 A1
(43) Pub. Date: Oct. 1, 2026

(54) INFORMATION REPORTING METHOD AND APPARATUS, AND DEVICE AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/472,483

(22) PCT Filed: Apr. 4, 2023
(86) PCT No.: PCT/CN2023/086319

§ 371 Date: Oct. 3, 2025

(51) Int. Cl. H04L 41/16; H04L 43/062

(52) U.S. Cl. CPC H04L 41/16; H04L 43/062

(57) ABSTRACT

An information reporting method includes determining an information reporting mode, where the information reporting mode includes at least one of reporting first information or reporting second information, the first information is used for indicating functionality information configured by a terminal based on artificial intelligence (AI) communication, and the second information is used for indicating model information configured by the terminal based on the AI communication. The method further includes reporting information to a network device based on the information reporting mode as determined.

### CROSS-REFERENCE TO RELATED APPLICATION

The present application is a U.S. National Stage of International Application No. PCT/CN 2023/086319, filed on Apr. 4, 2023, the entire content of which is incorporated herein by reference for all purposes.

### TECHNICAL FIELD

The present disclosure relates to the field of communication, particularly to an information reporting method and apparatus, a device and a storage medium.

### BACKGROUND

In recent years, artificial intelligence (AI) technologies have achieved continuous breakthroughs across a plurality of fields. The AI technology is progressively intersecting and penetrating with other disciplinary fields, providing new directions and methods for the development of different disciplines.

In the 3rd generation partnership project (3GPP), a research project related to the AI technology in the wireless air interface has been established. The project aims to study the introduction of the AI technology into the wireless air interface, as well as to explore how the AI technology can assist and enhance transmission technologies in the wireless air interface.

### SUMMARY

The present disclosure provides an information reporting method and apparatus, a device and a storage medium.

According to a first aspect of embodiments of the present disclosure, there is provided an information reporting method performed by a terminal. The method includes:
determining an information reporting mode, where the information reporting mode includes reporting first information and/or reporting second information, the first information is used for indicating functionality information configured by the terminal based on AI communication, and the second information is used for indicating model information configured by the terminal based on the AI communication; and reporting information to a network device based on the information reporting mode as determined.

According to a second aspect of the embodiments of the present disclosure, there is provided an information reporting method performed by a network device. The method includes receiving information reported by a terminal, where the information includes first information and/or second information, the first information is used for indicating functionality information configured by the terminal based on AI communication, and the second information is used for indicating model information configured by the terminal based on model communication.

According to a third aspect of the embodiments of the present disclosure, there is provided an information reporting device. The device includes:
a processor; and
a memory, configured to store an instruction executable by the processor;
where the processor is configured to perform the information reporting method according to the first aspect or any one of embodiments in the first aspect.

According to a fourth aspect of the embodiments of the present disclosure, there is provided an information reporting device. The device includes:
a processor; and
a memory, configured to store an instruction executable by the processor;
where the processor is configured to perform the information reporting method according to the second aspect or any one of embodiments in the second aspect.

According to a fifth aspect of the embodiments of the present disclosure, there is provided a storage medium. The storage medium stores an instruction, where the instruction in the storage medium, when executed by a processor of a terminal, causes the terminal to be capable of performing the information reporting method according to the first aspect or any one of embodiments in the first aspect.

According to a sixth aspect of the embodiments of the present disclosure, there is provided a storage medium. The storage medium stores an instruction, where the instruction in the storage medium, when executed by a processor of a network device, causes the network device to be capable of performing the information reporting method according to the second aspect or any one of embodiments in the second aspect.

It should be understood that the foregoing general description and the subsequent detailed description are merely exemplary and explanatory, and cannot limit the present disclosure.

### BRIEF DESCRIPTION OF THE DRAWINGS

The accompanying drawings herein are incorporated into the specification and form a part of the specification, illustrate the embodiments in accordance with the present disclosure, and are used together with the specification to explain the principles of the present disclosure.

FIG. 1 is a schematic diagram of a wireless communication system illustrated according to an embodiment.

FIG. 2 is a flowchart of an information reporting method illustrated according to an embodiment.

FIG. 3 is a flowchart of an information reporting method illustrated according to an embodiment.

FIG. 4 is a schematic diagram of a method for implementing information reporting through interaction between a terminal and a network device illustrated according to an embodiment.

FIG. 5 is a structural block diagram of an information reporting apparatus illustrated according to an embodiment.

FIG. 6 is a structural block diagram of an information reporting apparatus illustrated according to an embodiment.

FIG. 7 is a block diagram of a device for information reporting illustrated according to an embodiment.

### DETAILED DESCRIPTION

Exemplary embodiments are described in detail herein, examples of which are indicated in the accompanying drawings. When the following description relates to the accompanying drawings, the same numerals in different accompanying drawings indicate the same or similar elements unless otherwise indicated. The embodiments described in the following exemplary embodiments do not represent all embodiments consistent with the present disclosure.

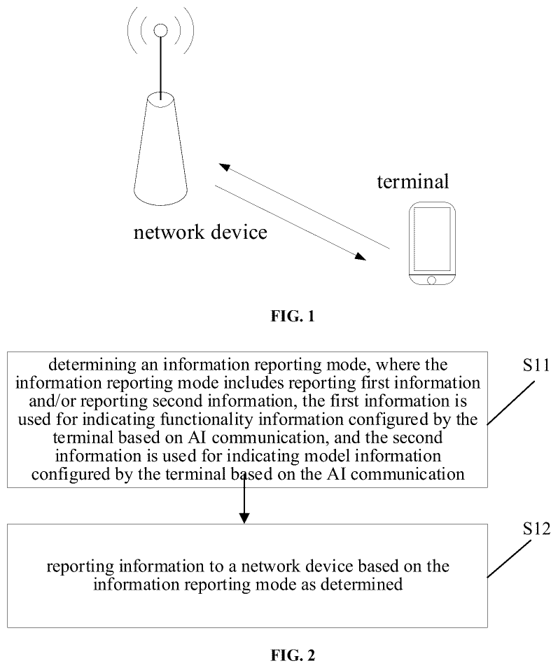

The communication method in the embodiments of the present disclosure may be applied to a wireless communication system shown in FIG. 1. Referring to FIG. 1, the wireless communication system includes a network device 10 and a terminal 11. The terminal and the network device are connected to each other through wireless resources and perform data transmissions.

It can be understood that the wireless communication system shown in FIG. 1 is merely for illustrative descriptions, and the wireless communication system may also include other network devices, such as a core network device, a wireless relay device, and a wireless backhaul device, etc., which are not shown in FIG. 1. The embodiments of the present disclosure do not limit the number of the network device(s) and the number of the terminal(s) included in the wireless communication system.

It can be further understood that the wireless communication system of the embodiments of the present disclosure is a network that provides a wireless communication functionality. The wireless communication system may use different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (SC-FDMA), or carrier sense multiple access/collision avoidance (carrier sense multiple access with collision avoidance). Based on factors such as capacity, rate, or latency of different networks, the networks may be categorized as a 2G (generation) network, a 3G network, a 4G network, or a future evolved network, such as the fifth generation (5G) network. The 5G network may also referred to as a new radio (NR) network. For ease of description, the wireless communication network may sometimes be referred to as a network in the present disclosure.

Furthermore, the network device involved in the present disclosure may also be referred to as a wireless access network device. The wireless access network device may be a base station, an evolved base station (evolved node B, base station), a home base station, an access point (AP) in a wireless fidelity (WiFi) system, a wireless relay node, a wireless backhaul node, a transmission point (TP), or a transmission and reception point (TRP), etc. The wireless access network device may also be a gNB in an NR system, or a component or a part of a device constituting a base station. It should be understood that the specific technology and the specific device form adopted by the network device are not limited in the embodiments of the present disclosure. In the present disclosure, the network device may provide communication coverage for specific geographic areas, and may communicate with terminals located in that coverage area (cell). In addition, in a case of a vehicle-to-everything (V2X) communication system, the network device may also be a vehicle-mounted device.

Furthermore, the terminal involved in the present disclosure may also be referred to as a terminal device, a user equipment (UE), a mobile station (MS), a mobile terminal (MT), etc., and is a device that provides voice and/or data connectivity to a user. For example, the terminal may be a handheld device or vehicle-mounted device with a wireless connection functionality. Currently, some examples of the terminal include: a smart phone (mobile phone), a customer premise equipment (CPE), a pocket personal computer (PPC), a handheld computer, a personal digital assistant (PDA), a laptop, a tablet, a wearable device, or a vehicle-mounted device, etc. Furthermore, in a case of a V2X communication system, the terminal device may also be a vehicle-mounted device. It should be understood that the specific technology and the specific device form adopted by the terminal are not limited in the embodiments of the present disclosure.

The widespread application of the 5th generation mobile communication technology (5G) has brought tremendous changes to various aspects of people's lives. The internation telecommunication union (ITU) has proposed that 5G will penetrate into various fields in the future, and an all-round information ecosystem centered on users will be constructed. It can be seen that 5G, as a representative of emerging infrastructure, will reconstruct the information society in the future.

In recent years, AI technologies have achieved continuous breakthroughs across a plurality of fields, bringing convenience to people's lives while also promoting industrial upgrading in various industries. With the intersecting and penetrating of the AI technology with other disciplinary fields, while the development of the AI technology integrates knowledge from different disciplines, the AI technology also provides new directions and methods for the development of different disciplines.

Taking the communication industry as an example, in the Release 18 phase of the 3GPP standard organization, a research project related to the AI technology in the wireless air interface was designed in the content of the potential new project discussed and determined in the RANI working group. The project aims to study how to introduce the AI technology into the wireless air interface, as well as to explore how the AI technology can assist and enhance transmission technologies in the wireless air interface.

It can be understood that the wireless air interface refers to the air interface technology in the wireless communication. In the wireless communication technology, the air interface defines the technical specification of the radio wave connection between the terminal device and the network device, making the wireless communication as reliable as the wired communication. In the mobile device transmission, the air interface connects the mobile phone terminal with the base station through the wireless communication. In the mobile phone, the air interface defines the wireless transmission specification between the base station and the mobile phone, and it defines the use frequency and the bandwidth of each wireless channel, or the used encoding method.

In the related art, the application of AI in the communication field includes: AI-based channel state information (CSI) enhancement, AI-based beam management, and AI-based target positioning. To achieve the above applications, it is typically required to deploy corresponding AI models for AI at the terminal and/or the network device.

For the deployment schemes of AI at the terminal and/or the network device, the deployment schemes may be typically classified into three manners, including: deploying at the terminal, deploying at the network device, and simultaneously deploying at both the terminal and the network device. For the above three deployment schemes, when the terminal performs the data transmission to the network device, if the terminal wants to ensure that the deployed model information can be accurately transmitted to the opposite side, the terminal needs to determine the information reporting mode.

In the related art, for models deployed at the terminal and/or the network device, they are typically classified into the following two types, and management is performed based on the following two results: functionality identification and model identification. In an embodiment, the functionality identification is represented as model management based on the model functionality, that is, functionality information. For example, AI models for beam enhancement, AI models for positioning, etc. The model identification is represented as model management based on model information, that is, model information. In an embodiment, an AI feature or a machine learning feature (ML feature) may include one or more functionalities. Each functionality may be specific to a specific application environment or application scenario.

In an embodiment, the AI/ML feature involved in the embodiments of the present disclosure may be an AI/ML use case. For example, the AI/ML feature may be a CSI compression, or a time-domain CSI prediction, or an AI-based spatial beam prediction, etc.

In an embodiment, one functionality may include one or more AI models.

It can be understood that during the data transmission between the terminal and the network device, due to the possible various situations of model deployment between the terminal and the network device, if the terminal and the network device cannot reach a consensus and have a consistent understanding on the information reporting mode, there will be various scenarios of mismatch in the AI-based communication process between the terminal and the network device, which leads to problems in the AI-based communication between the terminal and the network device.

In view of this, the embodiments of the present disclosure provide an information reporting method to determine the approach for AI processing identification. That is, it is required to define the information reporting mode based on the management schemes of the model functionality information and the model information described above.

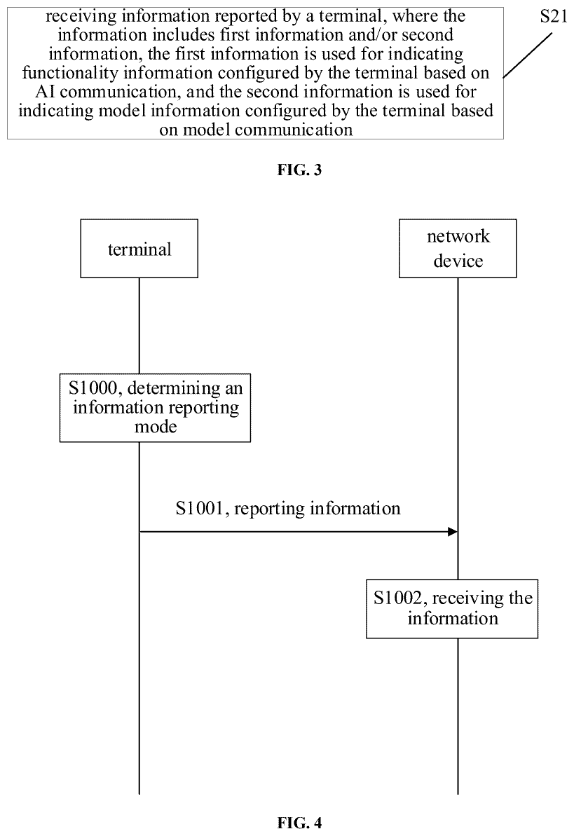

FIG. 2 is a flowchart of an information reporting method illustrated according to an embodiment. As shown in FIG. 2, the information reporting method is performed by a terminal and includes the following steps S11 to S12.

At step S11, an information reporting mode is determined, where the information reporting mode includes reporting first information and/or reporting second information. The first information is used for indicating functionality information configured by the terminal based on AI communication, and the second information is used for indicating model information configured by the terminal based on the AI communication.

In an embodiment of the present disclosure, the identification to be reported by the terminal may typically be classified into the functionality identification and the model identification. For the convenience of description, the two different reporting modes included in the information reporting mode are respectively referred to as reporting the first information and reporting the second information. In an embodiment, the first information and the second information are different from each other. The first information is used for indicating the functionality information configured by the terminal based on the AI communication. The second information is used for indicating the model information configured by the terminal based on the AI communication.

In an embodiment, the information reporting mode includes reporting the first information, or reporting the second information, or reporting the first information and the second information. It can also be understood that the relevant information of the functionality information management obtained based on the model corresponds to the first information, and the information based on the model information management corresponds to the second information.

At step S12, information is reported to a network device based on the information reporting mode as determined.

In an embodiment of the present disclosure, reporting, by the terminal, the information to the network device includes reporting the functionality identification and/or the model identification.

For example, the terminal reports the functionality identification of the model based on the information reporting mode. For example, the terminal pre-deploys three models A, B, and C, where model A has a beam prediction functionality, and models B and C have a beam enhancement functionality respectively. If the terminal needs to report the model having the beam prediction functionality by using the mode for reporting the functionality identification, the information (i.e., the first information) reported to the network device is the model corresponding to A, that is, model A.

For example, the terminal reports the model identification of the model based on the information reporting mode. For example, the terminal pre-deploys three models A, B, and C, where model A has a beam prediction functionality, and models B and C have a beam enhancement functionality respectively. If the terminal needs to report the model with the number “B” by using the mode for reporting the model identification, the information (i.e., the second information) reported to the network device is the model corresponding to B, that is, model B. It should be understood that the mode for reporting the first information may be that the terminal reports the functionality identification to the network device. Reporting the second information may be that the terminal reports the model identification to the network device.

In the information reporting method provided by the embodiments of the present disclosure, the terminal can select the reporting mode based on two different model management patterns, defining the information reporting mode as reporting the first information and/or reporting the second information.

In an embodiment, the determination of the information reporting mode may be determined through a preset condition. It can also be understood as selecting whether to use the functionality identification or the model identification based on a preset condition. In an embodiment, for the convenience of description, the preset condition for the terminal to select whether to use the functionality identification or the model identification is called a first preset condition. That is, based on the first preset condition, it is determined to report the first information or the second information.

In an embodiment of the present disclosure, it is assumed that the first preset condition is set as follows: if the first preset condition is satisfied, the first information is reported, and if the preset condition is not satisfied, the second information is reported. Thus, the selection of the information reporting mode is defined.

In the embodiments of the present disclosure, based on different preset condition settings, the selection of different types of information reporting modes corresponding to the preset condition can be made, which can define the information reporting mode of the terminal in different situations described by the preset condition.

In an embodiment, for the determination of the information reporting mode, the first preset condition may be set to determine whether to report the first information or the second information specifically. The content of the first preset condition as set may include: based on a model transmission status, that is, whether a model transmission exists; or based on a deployment type of a model.

In an embodiment, the situation of the current information transmission environment may be determined through whether a model transmission exists. It should be understood that the situation corresponding to the model transmission mentioned here may refer to a model that has been developed or trained by the terminal in the literal sense, where the model is sent to the network side for deployment or other subsequent uses. It may also correspond to the data related to the model currently deployed at the terminal, such as relevant tags used for describing the model functionality, and corresponding parameters of the model, etc.

In an embodiment, if the first preset condition is determined based on whether the model transmission exists, the corresponding information reporting mode relationship may be indicated as:
if no model transmission exists, the first information is reported; and
if the model transmission exists, the second information is reported.

In the embodiments of the present disclosure, a definite explanation is provided for the information reporting mode corresponding to the situation where the preset condition is determined based on whether a model transmission exists. When no model or corresponding model information transmission exists in the current data transmission environment, for example, the corresponding situation is that the model deployed at the terminal is only used for training at the terminal, and the network device only performs static management on the model information, without involving the use or development of the model, then, it is stipulated that the terminal only uses the functionality information of the model for reporting, that is, reports the first information. If a model or corresponding model information transmission exists in the current data transmission environment, then, it is stipulated that the terminal selects the model information of the model for reporting, that is, reports the second information.

In the information reporting method provided by the embodiments of the present disclosure, the reporting modes corresponding to the model transmission statuses are definitely defined and classified, enabling that the information reporting mode is specifically defined.

In an embodiment, the situation of the current deployment of the model may be determined through the deployment type of the model. Typically, the deployment type of the model includes one-sided model deployment and two-sided model deployment. It can be understood that the one-sided deployment refers to the model deployment at the terminal or at the network device. The two-sided deployment refers to the simultaneous model deployment at both the terminal and the network device.

It should be understood that whether the model transmission exists and the deployment type of the model described above may be in a progressive determination relationship, or may be in a parallel determination relationship of selecting one of the two. For example, whether the model transmission exists may first be determined, and then the deployment type of the model is determined; or one of whether the model transmission exists and the deployment type of the model may be selected for determination. The specific selection manner is selected based on the actual situation.

In the information reporting method provided by the embodiment, based on whether the model transmission exists and the deployment type of the model, the information reporting mode can be considered based on the information transmission environment and the model deployment situation, enabling that the selection of the information reporting mode is determined based on the terminal itself, which enables the terminal to have a more definite selection for the information reporting mode.

In an embodiment of the present disclosure, a definite explanation is provided for the information reporting mode corresponding to the situation where the preset condition is determined based on the deployment type of the model. When the deployment mode is determined to be the one-sided deployment, that is, when the model is deployed at the terminal or only at the network device, it is stipulated that the terminal uses the functionality information of the model for reporting, that is, reports the first information. When the deployment mode is determined to be the two-sided deployment, that is, when the model is deployed simultaneously at both the terminal and the network device, it is stipulated that the terminal selects the model information of the model for reporting, that is, reports the second information.

In an embodiment, the information reporting mode may also be determined based on preconfigured information of the network device. The preconfigured information of the network device for configuring the information reporting mode is referred to as first preconfigured information. The terminal determines to report the first information or report the second information based on the first preconfigured information.

The information reporting method provided by the embodiment can achieve that the terminal determines the information reporting mode based on the preconfigured information of the network device, improving the adaptability of the terminal in selecting the information reporting mode in the network environment.

In an embodiment, in determination of reporting the first information or the second information based on the first preconfigured information, the first preconfigured information may be system information. The system information indicates reporting the first information or reporting the second information.

In the embodiments of the present disclosure, a definite explanation is provided for the reporting mode when the first preconfigured information is the system information. The system information may be added with the content used for indicating the terminal to report the first information or report the second information. The system information added with the content used for indicating the terminal to report the first information or report the second information may be used for indicating the terminal the selection of information reporting.

The information reporting method provided by the embodiment allows the network device to broadcast in the system message whether the identification mode selected by the terminal is to report the functionality identification or the model identification. This achieves that the terminal determines the information reporting mode based on the system information, improving the adaptability of the terminal in selecting the information reporting mode in the network environment.

In an embodiment of the information reporting method provided by the embodiments, the terminal always performs the functionality identification, and whether to perform the model identification may be determined based on a preset condition or configuration.

In an embodiment, the terminal determines to report the first information by default, and/or determines to report the second information based on a second preset condition or second preconfigured information.

One case involving the terminal reporting information in an embodiment of the present disclosure is that the terminal is set to report the functionality information by default, i.e., reports the first information.

One case involving the terminal reporting information in an embodiment of the present disclosure is determining to report the second information based on the second preset condition or the second preconfigured information.

One case involving the terminal reporting information in an embodiment of the present disclosure is that the terminal determines to report the first information by default, and determines to report the second information based on the second preset condition or the second preconfigured information.

In an embodiment of the present disclosure, the terminal is set to report the functionality information by default, i.e., reports the first information. The terminal may change to report the second information based on the second preset condition or the second preconfigured information.

In an embodiment of the present disclosure, the terminal is set to report the functionality information by default, i.e., reports the first information. The terminal may change to report the first information and the second information based on the second preset condition or the second preconfigured information.

It can be understood that, in an embodiment of the present disclosure, the terminal may determine not to report the second information based on the second preset condition or the second preconfigured information, for example, in the cases where the second preset condition is not satisfied or the second preconfigured information does not indicate the reporting of the second information. In an embodiment, in determination of reporting the first information or the second information based on the second preset condition, the second preset condition may be determined based on a local policy of the terminal.

In an embodiment of the present disclosure, for the second preset condition, a definite explanation is provided for the reporting mode based on the policy of the terminal. For example, two policies are preset for the model at the terminal, namely policy C and policy D. The execution policy of the model and the information reporting mode of the terminal may be predefined. For example, when the model executes policy C, the terminal reports the first information. When the model executes policy D, the terminal reports the second information.

In the information reporting method provided by the embodiment, the information reporting mode corresponding to the policy that corresponds to the terminal model is defined, making the selection of the information reporting mode more specific, and enabling the terminal to determine the information reporting mode more definitely.

In an embodiment, in determination of reporting the first information or reporting the second information based on the second preconfigured information, the second preconfigured information may be determined by the network device based on a performance monitoring result.

In an embodiment of the present disclosure, when the terminal reports the first information, if the network device detects that the performance (signal strength or signal stability, etc.) corresponding to the terminal is affected, for example, there are significant fluctuations (exceeding the corresponding expected value as set), or significant performance degradation (exceeding the corresponding expected value as set) of the terminal, the network device determines whether to perform the model identification based on this situation.

Based on the above embodiments, the terminal may initially perform the functionality identification, but does not perform the model identification. In an embodiment, the terminal may perform the model selection and switching, etc. based on the local strategy of the terminal. The network device may determine whether to further perform the model identification based on the later performance monitoring result. For example, when the network detects significant fluctuations in the performance of the terminal or rapid performance degradation of the terminal, the network may request the terminal to perform the model identification.

Based on the same concept, the embodiments of the present disclosure also provide an information reporting method performed by a network device.

FIG. 3 is a flowchart of an information reporting method illustrated according to an embodiment. As shown in FIG. 3, the method includes the following step S21.

At step S21, information reported by a terminal is received, where the information includes first information and/or second information. The first information is used for indicating functionality information configured by the terminal based on AI communication, and the second information is used for indicating model information configured by the terminal based on model communication.

In an embodiment of the present disclosure, the reporting information by the terminal to the network device includes: reporting the functionality information (i.e., first information), and/or reporting specific information of the model (i.e., second information), such as reporting the functionality identification and/or the model identification.

The information and the information reporting mode involved in the embodiment of the present disclosure are consistent with the content involved in the execution process of the information reporting mode performed by the terminal in the above embodiments, and will not be described in detail here.

In an embodiment, the information reporting mode is determined based on a first preset condition, and includes reporting the first information or reporting the second information.

In an embodiment of the present disclosure, it is assumed that the first preset condition is set as follows: if the first preset condition is satisfied, the first information is reported, and if the preset condition is not satisfied, the second information is reported. Thus, the selection of the information reporting mode is defined.

In the embodiments of the present disclosure, based on different preset condition settings, the selection of different types of information reporting modes corresponding to the preset condition can be made, which can define the information reporting mode of the terminal in different situations described by the preset condition.

In an embodiment, for the determination of the information reporting mode, the first preset condition may be set to determine whether to report the first information or the second information specifically. In an embodiment, the first preset condition is determined based on at least one of the following: whether a model transmission exists, and a deployment type of a model.

In an embodiment, if the first preset condition is determined based on whether a model transmission exists, the corresponding information reporting mode relationship may be indicated as:
if no model transmission exists, the first information is reported; and
if the model transmission exists, the second information is reported.

In the embodiments of the present disclosure, a definite explanation is provided for the information reporting mode corresponding to the situation where the preset condition is determined based on whether a model transmission exists. When no model or corresponding model information transmission exists in the current data transmission environment, for example, the corresponding situation is that the model deployed at the terminal is only used for training at the terminal, and the network device only performs static management on the model information, without involving the use or development of the model, then, it is stipulated that the terminal only uses the functionality information of the model for reporting, that is, reports the first information. If a model or corresponding model information transmission exists in the current data transmission environment, then, it is stipulated that the terminal selects the model information of the model of the model for reporting, that is, reports the second information.

In the information reporting method provided by the embodiments of the present disclosure, the reporting modes corresponding to the model transmission statuses are definitely defined and classified, enabling that the information reporting mode is specifically defined.

In an embodiment, the situation of the current deployment of the model may be determined through the deployment type of the model. Typically, the deployment type of the model includes one-sided model deployment and two-sided model deployment. It can be understood that the one-sided deployment refers to the model deployment at the terminal or at the network device. The two-sided deployment refers to the simultaneous model deployment at both the terminal and the network device.

It should be understood that whether the model transmission exists and the deployment type of the model described above may be in a progressive determination relationship, or may be in a parallel determination relationship of selecting one of the two. For example, whether the model transmission exists may first be determined, and then the deployment type of the model is determined; or one of whether the model transmission exists and the deployment type of the model may be selected for determination. The specific selection manner is selected based on the actual situation.

In the information reporting method provided by the embodiment, based on whether the model transmission exists and the deployment type of the model, the information reporting mode can be considered based on the information transmission environment and the model deployment situation, enabling the selection of the information reporting mode to be more specific, which enables the terminal to have a definite selection for the information reporting mode.

In an embodiment of the present disclosure, a definite explanation is provided for the information reporting mode corresponding to the situation where the preset condition is determined based on the deployment type of the model. When the deployment mode is determined to be the one-sided deployment, that is, when the model is deployed at the terminal or only at the network device, it is stipulated that the terminal uses the functionality information of the model for reporting, that is, reports the first information. When the deployment mode is determined to be the two-sided deployment, that is, when the model is deployed simultaneously at both the terminal and the network device, it is stipulated that the terminal selects the model information of the model for reporting, that is, reports the second information.

In the information reporting method provided by the embodiment, the reporting mode corresponding to the deployment situation or the deployment type as applied is definitely defined and classified, enabling the selection of the information reporting mode to be more specific, which enables the terminal to have a more definite selection for the information reporting mode.

In an embodiment, for the determination of the information reporting mode, the determination of reporting the first information or reporting the second information may also be based on first preconfigured information.

In an embodiment of the present disclosure, the determination of the information reporting mode of the terminal may also be achieved through network pre-configuration, provided that there is a network environment.

The information reporting method provided by the embodiment achieves that the terminal can dynamically determine the information reporting mode, improving the adaptability of the terminal in selecting the information reporting mode in the network environment.

In an embodiment, in determination of reporting the first information or the second information based on the first preconfigured information, the first preconfigured information may be system information, and is used for indicating the terminal to report the first information or indicating the terminal to report the second information.

In the embodiments of the present disclosure, a definite explanation is provided for the reporting mode when the first preconfigured information is the system information. The system information may be added with the content used for indicating the terminal to report the first information or report the second information. The system information added with the content used for indicating the terminal to report the first information or report the second information may be used for indicating the terminal the selection of information reporting.

The information reporting method provided in the embodiment achieves that the terminal can dynamically determine the information reporting mode based on the system information, improving the adaptability of the terminal in selecting the information reporting mode in the network environment.

In an embodiment, the determination of the information reporting mode may also be implemented through the following steps: determining to report the first information by default, and/or determining to report the second information based on a second preset condition or second preconfigured information.

One case involving the terminal reporting information in an embodiment of the present disclosure is that the terminal is set to report the functionality information by default, i.e., reports the first information.

One case involving the terminal reporting information in an embodiment of the present disclosure is determining to report the second information based on the second preset condition or the second preconfigured information.

One case involving the terminal reporting information in an embodiment of the present disclosure is that the terminal determines to report the first information by default, and determines to report the second information based on the second preset condition or the second preconfigured information.

In an embodiment of the present disclosure, the terminal is set to report the functionality information by default, i.e., reports the first information. The terminal may change to report the second information based on the second preset condition or the second preconfigured information.

In an embodiment of the present disclosure, the terminal is set to report the functionality information by default, i.e., reports the first information. The terminal may change to report the first information and the second information based on the second preset condition or the second preconfigured information.

It can be understood that, in an embodiment of the present disclosure, the terminal may determine not to report the second information based on the second preset condition or the second preconfigured information, for example, in the cases where the second preset condition is not satisfied or the second preconfigured information does not indicate the reporting of the second information.

In an embodiment, in determination of reporting the first information or the second information based on the second preset condition, the second preset condition may be determined based on a local policy of the terminal.

In an embodiment of the present disclosure, for the second preset condition, a definite explanation is provided for the reporting mode based on the policy of the terminal. For example, two policies are preset for the model at the terminal, namely policy C and policy D. The execution policy of the model and the information reporting mode of the terminal may be predefined. For example, when the model executes policy C, the terminal reports the first information. When the model executes policy D, the terminal reports the second information.

In the information reporting method provided by the embodiment, the information reporting mode corresponding to the policy that corresponds to the terminal model is defined, making the selection of the information reporting mode more specific, and enabling the terminal to determine the information reporting mode more definitely.

In an embodiment, in determination of reporting the first information or reporting the second information based on the second preconfigured information, the second preconfigured information may be determined by the network device based on a performance monitoring result.

In an embodiment of the present disclosure, when the terminal reports the first information, if the network device detects that the performance (signal strength or signal stability, etc.) corresponding to the terminal is affected, for example, there are significant fluctuations (exceeding the corresponding expected value as set), or significant performance degradation (exceeding the corresponding expected value as set) of the terminal, the network device determines whether to perform the model identification based on this situation.

In this way, the information reporting mode is defined when the second preconfigured information corresponding to the terminal model is determined based on the performance detection result, enabling the selection of the information reporting mode to be more specific, which enables the terminal to determine the information reporting mode more definitely.

It can be understood that the information reporting method provided in the embodiments of the present disclosure is applicable to the process for implementing information reporting through interaction between a terminal and a network device in a communication system.

FIG. 4 is a schematic diagram of a method for implementing information reporting through interaction between a terminal and a network device. As shown in FIG. 4, the embodiment of the present disclosure relates to an information reporting method for a communication system, and the method includes the following steps S1000 to S1002.

At step S1000, the terminal determines an information reporting mode.

In some embodiments, the information reporting mode includes reporting first information and/or reporting second information. The first information is used for indicating the functionality information configured by the terminal based on the AI communication. The second information is used for indicating the model information configured by the terminal based on the AI communication.

For example, the identification to be reported by the terminal may typically be classified into the functionality identification and the model identification. For the convenience of description, the two different reporting modes included in the information reporting mode are respectively referred to as reporting the first information and reporting the second information. In an embodiment, the first information and the second information are different from each other. The first information is used for indicating the functionality information configured by the terminal based on the AI communication. The second information is used for indicating the model information configured by the terminal based on the AI communication.

In an embodiment, the information reporting mode includes reporting the first information, or reporting the second information, or reporting the first information and the second information. It can also be understood that the relevant information of the functionality information management obtained based on the model corresponds to the first information, and the information based on the model information management corresponds to the second information.

At step S1001, the terminal reports information to the network device.

In some embodiments, the mode of reporting the first information may be that the terminal reports the functionality identification to the network device. The mode of reporting the second information may be that the terminal reports the model identification to the network device.

At step S1002, the network device receives the information reported by the terminal.

In some embodiments, the information reporting mode includes reporting first information and/or reporting second information. The first information is used for indicating the functionality information configured by the terminal based on the AI communication. The second information is used for indicating the model information configured by the terminal based on the model communication.

The information reporting method involved in the embodiments of the present disclosure may include at least one of steps S1000 to S1002. For example, step S1000 may be implemented as an independent embodiment, step S1002 may be implemented as an independent embodiment, step S1000+step S1002 may be implemented as an independent embodiment, step S1000+step S1001+step S1002 may be implemented as an independent embodiment, but not limited to these. In some embodiments, step S1001 is optional, and one or more of these steps may be omitted or replaced in different embodiments.

It should be noted that those skilled in the art can understand that various implementations/embodiments involved in the embodiments of the present disclosure may be used in conjunction with the aforementioned embodiments or may be used independently. Whether various implementations/embodiments involved in the embodiments of the present disclosure are used independently or in conjunction with the aforementioned embodiments, the implementation principles are similar. In the implementations of the present disclosure, a part of the embodiments is described by using examples in which the embodiments are used together. Of course, those skilled in the art can understand that such examples are not limitations on the embodiments of the present disclosure.

Based on the same concept, the embodiments of the present disclosure further provide an information reporting apparatus.

It can be understood that in order to achieve the above functions, the information reporting apparatus provided by the embodiments of the present disclosure include a hardware structure and/or a software module corresponding to the execution of each function. In combination with the units and algorithm steps of each example disclosed in the embodiments of the present disclosure, the embodiments of the present disclosure may be implemented in the form of hardware or a combination of hardware and computer software. Whether a function is executed in the form of hardware or computer software driving hardware depends on a specific application and design constraints of the technical solutions. Those skilled in the art may use different methods to implement the described functions for each specific application, but such implementation should not be considered as beyond the scope of the technical solutions of the embodiments of the present disclosure.

FIG. 5 is a structural block diagram of an information reporting apparatus illustrated according to an embodiment. The information reporting apparatus may be a terminal, or may be a component in a terminal.

As shown in FIG. 5, the information reporting apparatus 100 includes a processing unit 101 and a sending unit 102.

The processing unit 101 is configured to determine an information reporting mode, where the information reporting mode includes reporting first information and/or reporting second information, the first information is used for indicating functionality information configured by the terminal based on AI communication, and the second information is used for indicating model information configured by the terminal based on the AI communication.

The sending unit 102 is configured to report information to a network device based on the information reporting mode as determined.

In an embodiment, the processing unit 101 is configured to determine the information reporting mode by using the following manners: determining to report the first information or report the second information based on a first preset condition.

In an embodiment, the first preset condition is determined based on at least one of:
whether a model transmission exists; and a deployment type of a model.

In an embodiment, the first preset condition is determined based on whether the model transmission exists; and the determining to report the first information or report the second information based on the first preset condition includes: if no model transmission exists, reporting the first information; or if the model transmission exists, reporting the second information.

In an embodiment, the processing unit 101 determines the information reporting mode by using the following manners: determining to report the first information or report the second information based on first preconfigured information.

In an embodiment, the first preconfigured information is system information, and the system information indicates reporting the first information or reporting the second information.

In an embodiment, the processing unit 101 determines the information reporting mode by using the following manners:
determining to report the first information by default, and/or determining to report the second information based on a second preset condition or second preconfigured information.

In an embodiment, the second preset condition is determined based on a local policy of the terminal.

In an embodiment, the second preconfigured information is determined by the network device based on a performance monitoring result.

Based on the same concept, the embodiments of the present disclosure further provide an information reporting apparatus. The information reporting apparatus may be a network device, or may be a component in a network device.

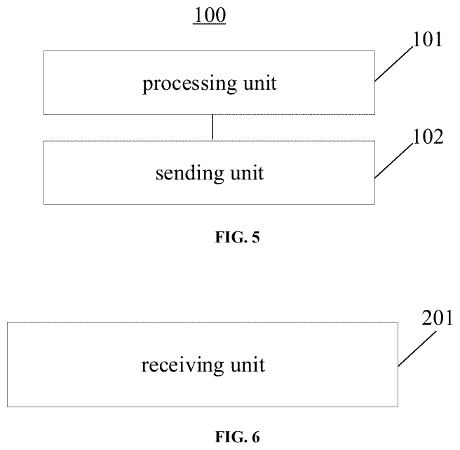

As shown in FIG. 6, FIG. 6 is a structural block diagram of an information reporting apparatus illustrated according to an embodiment.

The embodiment of the present disclosure provides an information reporting apparatus including a receiving unit 201.

The receiving unit 201 is configured to receive information reported by a terminal, where the information includes first information and/or second information, the first information is used for indicating functionality information configured by the terminal based on AI communication, and the second information is used for indicating model information configured by the terminal based on model communication.

In an embodiment, an information reporting mode is determined based on a first preset condition, and includes reporting the first information or reporting the second information.

In an embodiment, the first preset condition is determined based on at least one of: whether a model transmission exists; and a deployment type of a model.

In an embodiment, the first preset condition includes: if a model is a one-sided model, the information reporting mode includes reporting the first information; or if the model is a two-sided model, the information reporting mode includes reporting the second information.

In an embodiment, the receiving unit 201 determines an information reporting mode based on first preconfigured information, and the information reporting mode includes reporting the first information or reporting the second information.

In an embodiment, the first preconfigured information is system information, the first preconfigured information is sent by the network device to indicate the terminal to report the first information or indicate the terminal to report the second information.

In an embodiment, the receiving unit 201 receives the information reported by the terminal by using the following manners: receiving the first information reported by the terminal by default, and/or receiving the second information reported by the terminal in response to second preconfigured information or determining that a second preset condition is satisfied.

In an embodiment, the second preset condition is determined based on a local policy of the terminal.

In an embodiment, the second preconfigured information is determined by the network device based on a performance monitoring result.

Regarding the apparatuses in the above embodiments, the specific manner in which each module performs operations has been described in detail in the embodiments related to the methods, and will not be elaborated in detail here.

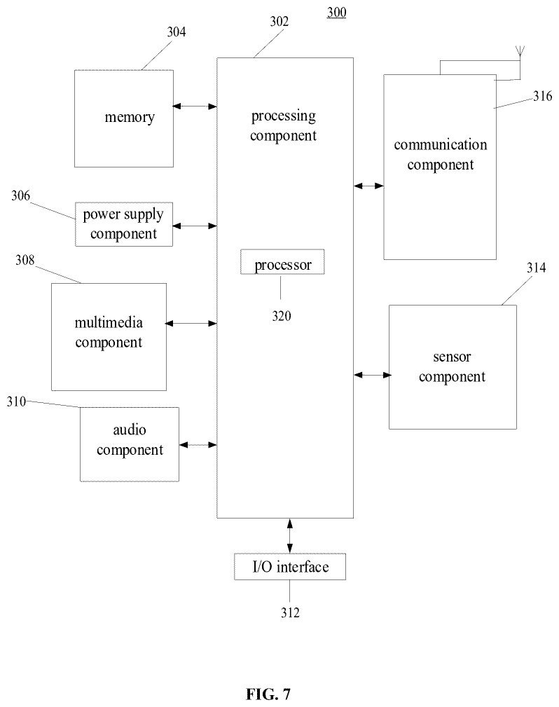

FIG. 7 is a block diagram of a device 300 for information reporting illustrated according to an embodiment. For example, the device 300 may be a mobile phone, a computer, a digital broadcast terminal, a messaging device, a gaming console, a tablet, a medical device, a fitness device, a personal digital assistant, and the like.

Referring to FIG. 7, the device 300 may include one or more of the following components: a processing component 302, a memory 304, a power supply component 306, a multimedia component 308, an audio component 310, an input/output (I/O) interface 312, a sensor component 314, and a communication component 316.

The processing component 302 generally controls an overall operation of the device 300, such as operations associated with display, telephone calls, data communication, camera operations, and recording operations. The processing component 302 may include one or more processors 320 to execute an instruction, thereby completing all or a part of the steps of the methods described above. In addition, the processing component 302 may include one or more modules that facilitate interaction between the processing component 302 and other components. For example, the processing component 302 may include a multimedia module to facilitate interaction between the multimedia component 308 and the processing component 302.

The memory 304 is configured to store various types of data to support operations at the device 300. Examples of such data include the following: instructions for any application program or method operated on the device 300, contact data, phonebook data, messages, pictures, videos, etc. The memory 304 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power supply component 306 supplies power to various components of the device 300. The power supply component 306 may include a power supply management system, one or more power supplies, and other components associated with generating, managing and distributing power for the device 300.

The multimedia component 308 includes a screen that provides an output interface between the device 300 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe operation. In some embodiments, the multimedia component 308 includes a front-facing camera and/or a rear-facing camera. The front-facing camera and/or the rear-facing camera may receive external multimedia data when the device 300 is in an operating mode, such as a shooting mode or a video mode. Each of the front-facing camera and the rear-facing camera may be a fixed optical lens system or have a focal length and optical zoom capability.

The audio component 310 is configured to output and/or input audio signals. For example, the audio component 310 includes a microphone (MIC). When the device 300 is in an operating mode, such as a calling mode, a recording mode and a voice recognition mode, the MIC is configured to receive external audio signals. The received audio signals may be further stored in the memory 304 or sent via the communication component 316. In some embodiments, the audio component 310 further includes a speaker for outputting the audio signals.

The I/O interface 312 provides an interface between the processing component 302 and a peripheral interface module. The peripheral interface module described above may be a keypad, a click wheel, a button, etc. These buttons may include, but are not limited to, a home button, a volume button, a start button, and a lock button.

The sensor component 314 includes one or more sensors configured to provide status assessment for various aspects of the device 300. For example, the sensor component 314 may detect an open/closed state of the device 300, relative positioning of the components, for example, the components are the display and small keypad of the device 300; the sensor component 314 may also detect a change in the position of the device 300 or a change in the position of one component of the device 300, the presence or absence of contact between the user and the device 300, the orientation or acceleration/deceleration of the device 300, and temperature changes of the device 300. The sensor component 314 may include a proximity sensor that is configured to detect the presence of nearby objects in the absence of any physical contact. The sensor component 314 may also include a light sensor, such as a CMOS or a CCD image sensor, for use in imaging applications. In some embodiments, the sensor component 314 may also include an accelerometer sensor, a gyroscope sensor, a magnetic sensor, a pressure sensor, or a temperature sensor.

The communication component 316 is configured to facilitate the communication between the device 300 and other devices by wired or wireless means. The device 300 may access a wireless network based on a communication standard, such as WiFi, 2G, 3G, or a combination thereof. In an embodiment, the communication component 316 receives broadcast signals or broadcast related information from an external broadcast management system via a broadcast channel. In an embodiment, the communication component 316 further includes a near-field communication (NFC) module to facilitate short-range communication. For example, the NFC module may be implemented based on the radio frequency identification (RFID) technology, the infrared data association (IrDA) technology, the ultra-wideband (UWB) technology, the Bluetooth (BT) technology, and the other technology.

In an embodiment, the device 300 may be implemented by one or more of the following: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic elements, for performing the above methods.

In an embodiment, a non-transitory computer-readable storage medium including an instruction is also provided, such as the memory 304 including an instruction. The instruction described above is capable of being executed by the processor 320 of the device 300 to complete the above methods. For example, the non-transitory computer-readable storage medium may be an ROM, a random access memory (RAM), a CD-ROM, a magnetic tape, a floppy disk, or an optical data storage device, etc.

A device for reporting information is provided. For example, the device may be provided as a network device. The device includes a processing component, which further include one or more processors, and a memory resource represented by a memory for storing an instruction executable by the processing component, such as an application program. The application program stored in the memory may include one or more modules each corresponding to a set of instructions. In addition, the processing component is configured to execute the instruction to perform the above methods.

The device may also include a power supply component configured to perform power supply management of the device, a wired or wireless network interface configured to connect the device to the network, and an I/O interface. The device may operate on operating systems stored in the memory, such as Windows Server™, Mac OS X™, Unix™, Linux™, FreeBSD™, or the like.

In an embodiment, a non-transitory computer-readable storage medium including an instruction is also provided, such as the memory including an instruction. The instruction described above is capable of being executed by the processing component of the device to complete the above methods. For example, the non-transitory computer-readable storage medium may be an ROM, an RAM, a CD-ROM, a magnetic tape, a floppy disk, or an optical data storage device, etc.

The technical solutions provided by the embodiments of the present disclosure can include the following beneficial effects. In the present disclosure, the information reporting mode for the functionality information configured for the AI communication and the model information configured for the AI communication is determined, and the functionality information configured for the AI communication and/or the model information configured for the AI communication is reported to the network device based on the determined information reporting mode. In this way, the reporting and processing modes of the terminal for the functionality information configured for the AI communication and the model information configured for the AI communication are defined.

It can be further understood that “a plurality of” in the present disclosure refers to two or more than two, and other quantifiers are similar. The expression “and/or” describes an association relationship of associated objects, indicating that three relationships may exist. For example, A and/or B may indicate: A exists alone, A and B exist simultaneously, and B exists alone. The character “/” generally indicates that associated objects before and after the character are in an “or” relationship. The singular forms “a/an”, “said” and “the” are also intended to include plural forms, unless the context clearly indicates other meanings.

It can be further understood that the meanings of the words “in response to” and “if” involved in the present disclosure depend on the context and the actual usage scenarios. For example, the word “in response to” used herein may be interpreted as “at the time of . . . ” or “when . . . ” or “if” or “in a case that”.

It can be further understood that the terms “first”, “second”, etc. are used to describe various information, but such information should not be limited to these terms. These terms are only used to distinguish the same type of information from each other, and do not indicate a specific order or degree of importance. In fact, the expressions “first”, “second”, etc. can be used interchangeably. For example, without departing from the scope of the present disclosure, the first information may also be referred to as the second information, and similarly, the second information may also be referred to as the first information.

It can be further understood that although operations are described in a specific order in the accompanying drawings in the embodiments of the present disclosure, it should not be understood as requiring the operations to be executed in the specific order shown in the drawings or in a serial order, or requiring the execution of all the operations shown in the drawings to obtain a desired result. In specific environments, multitasking and parallel processing may be advantageous.

After considering the specification and practicing the invention disclosed herein, those skilled in the art will easily come up with other implementation solutions of the present disclosure. The present application is intended to cover any variations, uses or adaptive changes of the embodiments of the present application, and the variations, uses or adaptive changes follow the general principles of the present disclosure and include common knowledge or commonly used technical means in the art that is not disclosed in the present disclosure.

It should be understood that the present disclosure is not limited to the precise structure which has been described above and illustrated in the accompanying drawings, and that various modifications and alterations may be made without departing from the scope of the present disclosure. The scope of the present disclosure is limited only by the appended claims.

1. An information reporting method, performed by a terminal, comprising:
determining an information reporting mode, wherein the information reporting mode comprises at least one of reporting first information or reporting second information, the first information is used for indicating functionality information configured by the terminal based on artificial intelligence (AI) communication, and the second information is used for indicating model information configured by the terminal based on the AI communication; and
reporting information to a network device based on the information reporting mode as determined.

2. The method according to claim 1, wherein the determining the information reporting mode comprises:
determining to report the first information or report the second information based on a first preset condition.

3. The method according to claim 2, wherein the first preset condition is determined based on at least one of:
whether a model transmission exists; or
a deployment type of a model.

4. The method according to claim 3, wherein the first preset condition is determined based on whether the model transmission exists; and
the determining to report the first information or report the second information based on the first preset condition comprises:
reporting the first information in response to determining that no model transmission exists; or
reporting the second information in response to determining that the model transmission exists.

5. The method according to claim 3, wherein the first preset condition is determined based on the deployment type of the model; and
the determining to report the first information or report the second information based on the first preset condition comprises:
reporting the first information in response to the model being a one-sided model; or
reporting the second information in response to the model being a two-sided model.

6. The method according to claim 1, wherein the determining the information reporting mode comprises:
determining to report the first information or report the second information based on first preconfigured information.

7. The method according to claim 6, wherein the first preconfigured information is system information, and the system information indicates reporting the first information or reporting the second information.

8. The method according to claim 1, wherein the determining the information reporting mode comprises:
performing at least one of determining to reporting the first information by default, or determining to report the second information based on a second preset condition or second preconfigured information.

9. The method according to claim 8, wherein the second preset condition is determined based on a local policy of the terminal.

10. The method according to claim 8, wherein the second preconfigured information is determined by the network device based on a performance monitoring result.

11. An information reporting method, performed by a network device, comprising:
receiving information reported by a terminal, wherein the information comprises at least one of first information or second information, the first information is used for indicating functionality information configured by the terminal based on artificial intelligence (AI) communication, and the second information is used for indicating model information configured by the terminal based on the AI communication.

12. The method according to claim 11, wherein an information reporting mode of the terminal is determined based on a first preset condition, and comprises reporting the first information or reporting the second information.

13. The method according to claim 12, wherein the first preset condition is determined based on at least one of:
whether a model transmission exists; or
a deployment type of a model.

14. The method according to claim 13, wherein the first preset condition is determined based on the deployment type of the model; comprises: and
the information reporting mode comprises reporting the first information in response to the model being a one-sided model; or the information reporting mode comprises reporting the second information in response to the model being a two-sided model.

15. The method according to claim 11, wherein an information reporting mode of the terminal is determined based on first preconfigured information, and comprises reporting the first information or reporting the second information.

16. The method according to claim 15, further comprising:
sending the first preconfigured information, wherein the first preconfigured information is system information, and is used for indicating the terminal to report the first information or indicating the terminal to report the second information.

17. The method according to claim 11, wherein the receiving the information reported by the terminal comprises:
performing at least one of receiving the first information reported by the terminal by default, or receiving the second information reported by the terminal in response to second preconfigured information or determining that a second preset condition is satisfied.

18. The method according to claim 17, wherein the second preset condition is determined based on a local policy of the terminal; or
the second preconfigured information is determined by the network device based on a performance monitoring result.

19. (canceled)

20. (canceled)

21. (canceled)

22. An information reporting device, comprising:
a processor; and
a memory, configured to store an instruction executable by the processor; wherein
the processor, through executing the instruction, is configured to:
determine an information reporting mode, wherein the information reporting mode comprises at least one of reporting first information or reporting second information, the first information is used for indicating functionality information configured by a terminal based on artificial intelligence (AI) communication, and the second information is used for indicating model information configured by the terminal based on the AI communication; and
report information to a network device based on the information reporting mode as determined.

23. A non-transitory computer-readable storage medium, storing an instruction that, when executed by a processor of a terminal, causes the terminal to be capable of performing the information reporting method according to claim 1.
